(19) United States
(12) Patent Application Publication
(10) Pub. No.: US 2026/0320206 A1
(43) Pub. Date: Oct. 15, 2026

(54) Efficient Execution of a Large-Language Model (LLM) on a Secure Neural Processing Unit

(71) Applicant: MediaTek Inc., Hsinchu City (TW)

(72) Inventors: Chih-Hsiang Hsiao, Hsinchu City (TW); Yi-Chan Li, Hsinchu City (TW); Chia-Feng Hsu, Hsinchu City (TW); Yi-Yun Hsieh, Hsinchu City (TW); Kai-Yu Chuang, Hsinchu City (TW)

(21) Appl. No.: 19/642,198

(22) Filed: Apr. 8, 2026

Related U.S. Application Data
(60) Provisional application No. 63/786,445, filed on Apr. 10, 2025.

(51) Int. Cl. G06F 21/60; G06F 9/50

(52) U.S. Cl. CPC G06F 21/606; G06F 9/5016

(57) ABSTRACT

A system securely executes an artificial intelligence (AI) model. The model weights are stored in a secure memory accessible to a neural processing unit (NPU) and a trusted execution environment (TEE) operating in a secure world on a host processor. The secure memory is inaccessible to processes running in a normal world on the host processor. A secure process in the TEE prepares the AI model for inference operations. The NPU receives a request for executing the AI model from an NPU driver operating in the normal world on the host processor, via a protected channel allocated with hardware dedicated to communication between the NPU driver and the NPU. The NPU generates inference output using the prepared AI model stored in the secure memory. The NPU stores the inference output in a protected memory for access by a virtual machine (VM) in the normal world on the host processor.

### CROSS-REFERENCE TO RELATED APPLICATIONS

This application claims the benefit of U.S. Provisional Application No. 63/786,445 filed on Apr. 10, 2025, the entirety of which is incorporated by reference herein.

### TECHNICAL FIELD

Embodiments of the invention relate to secure execution of artificial intelligence (AI) models.

### BACKGROUND OF THE INVENTION

Modern computing devices include specialized processors such as neural processing units (NPUs) to perform AI operations. In some systems, an NPU is also known as an artificial intelligence (AI) accelerator or AI processing unit (APU). An NPU is designed to accelerate AI and machine learning tasks by efficiently executing the mathematical operations required for tasks such as image recognition, natural language processing, predictive modeling, to name a few.

Proprietary AI models contain sensitive information such as model weights, intermediate activations, and inference logic. Some computing devices use a Trusted Execution Environment (TEE) for on-device AI model execution to reduce the risk of model theft, tampering, or data leakage, and enables stronger guarantees for handling user privacy and proprietary information. However, AI model execution that uses TEEs incurs a significant overhead and slows down inference operations. Therefore, there is a need for developing techniques for secure and efficient AI model execution.

### SUMMARY OF THE INVENTION

In one embodiment, a method is provided for secure execution of an AI model. The method comprises receiving a prompt to the AI model. Weights of the AI model are stored in a secure memory accessible to an NPU and a TEE operating in a secure world on a host processor, the secure memory inaccessible to processes running in a normal world on the host processor. A secure process in the TEE prepares the AI model for inference operations. The NPU receives a request for executing the AI model from an NPU driver operating in the normal world on the host processor. The request is received via a protected channel allocated with hardware dedicated to communication between the NPU driver and the NPU. Secure cores in the NPU generate output of the inference operations in response to the prompt using the prepared AI model stored in the secure memory. The NPU stores the output in a protected memory for access by a given VM in the normal world on the host processor. The given VM is granted access privilege to the protected memory.

In another embodiment, a system is operative to perform secure execution of an AI model. The system comprises: a system memory including a secure memory and a protected memory, an NPU including secure cores operating in a secure mode, and a host processor that runs VMs in a normal world and a TEE in a secure world. The system is operative to perform the aforementioned method, in which a secure process in the TEE prepares the AI model for inference operations, and the NPU receives a request for executing the AI model from an NPU driver operating in the normal world on the host processor via a protected channel allocated with hardware dedicated to communication between the NPU driver and the NPU.

In yet another embodiment, a method is provided for secure execution of an AI model. The method comprises receiving a prompt to the AI model. Weights of the AI model are stored in a secure memory accessible to an NPU operating in a secure world on a host processor and inaccessible to processes running in a normal world on the host processor. A microcontroller in the NPU prepares the AI model for inference operations. The microcontroller receives a request for executing the AI model from an NPU driver operating in the normal world on the host processor. The microcontroller provides hardware dedicated to communication between the NPU driver and the NPU. Secure cores in the NPU generate output of the inference operations in response to the prompt using the prepared AI model stored in the secure memory. The NPU stores the output in a protected memory for access by a given VM in the normal world on the host processor. The given VM is granted access privilege to the protected memory.

In yet another embodiment, a system is operative to perform secure execution of an AI model. The system comprises: a system memory including a secure memory and a protected memory, an NPU including a microcontroller and secure cores operating in a secure mode, and a host processor that runs VMs in a normal world. The system is operative to perform the aforementioned method, in which the microcontroller in the NPU prepares the AI model for inference operations, the microcontroller receives a request for executing the AI model from an NPU driver operating in the normal world on the host processor, and the microcontroller provides hardware dedicated to communication between the NPU driver and the NPU.

Other aspects and features will become apparent to those ordinarily skilled in the art upon review of the following description of specific embodiments in conjunction with the accompanying figures.

### BRIEF DESCRIPTION OF DRAWINGS

The present invention is illustrated by way of example, and not by way of limitation, in the figures of the accompanying drawings in which like references indicate similar elements. It should be noted that different references to "an" or "one" embodiment in this disclosure are not necessarily to the same embodiment, and such references mean at least one. Further, when a particular feature, structure, or characteristic is described in connection with an embodiment, it is submitted that it is within the knowledge of one skilled in the art to effect such feature, structure, or characteristic in connection with other embodiments whether or not explicitly described.

FIG. 1 is a diagram illustrating a system in which secure AI model inference may be performed according to one embodiment.

FIG. 2 illustrates a process of LLM inference operations according to one embodiment.

FIG. 3 is a diagram illustrating a control flow of AI model inference operations according to a first embodiment.

FIG. 4 is a diagram illustrating a control flow of AI model inference operations according to a second embodiment.

FIG. 5 is a diagram illustrating a system in which secure AI model inference may be performed according to another embodiment.

FIG. 6 is a diagram illustrating a control flow of AI model inference operations according to a third embodiment.

FIG. 7 is a diagram illustrating a control flow of AI model inference operations according to a fourth embodiment.

FIG. 8 is a flow diagram illustrating a method of secure execution of an AI model according to one embodiment.

FIG. 9 is a flow diagram illustrating a method of secure execution of an AI model according to another embodiment.

### DETAILED DESCRIPTION OF THE INVENTION

In the following description, numerous specific details are set forth. However, it is understood that embodiments of the invention may be practiced without these specific details. In other instances, well-known circuits, structures, and techniques have not been shown in detail in order not to obscure the understanding of this description. It will be appreciated, however, by one skilled in the art, that the invention may be practiced without such specific details. Those of ordinary skill in the art, with the included descriptions, will be able to implement appropriate functionality without undue experimentation.

Systems and methods for secure, efficient, and scalable AI model execution are described herein. In one embodiment, the AI model is a large language model (LLM). Proprietary model data (e.g., model weights) and metadata (e.g., hyperparameters) are stored in a secure portion of a system memory (referred to as “secure memory”). The secure memory is accessible only to secure cores in an NPU and a trusted execution environment (TEE) operating on a host processor (e.g., a central processing unit (CPU)). The TEE protects sensitive operations from unauthorized access or attacks during execution. The TEE runs in a secure world on the host processor. The execution environment on the host processor outside the TEE is referred to as the normal world.

As used herein, the terms “normal world” and “secure world” refer to hardware-enforced partitions on a host processor such as a CPU. The normal world runs untrusted operating systems and applications, while the secure world runs an isolated execution environment in parallel to the normal world. The secure world has access to a secure memory and secure communication channels to co-processors (e.g., secure cores in an NPU) and peripheral devices. The term “secure cores in an NPU” refers to NPU cores that are configured to run in a secure mode with isolated resources in the NPU.

To prepare an AI model for inference operations, an application that runs in the normal world may invoke a secure process in the TEE to perform model preparation using the model data in the secure memory. After the model is prepared, an NPU driver in the normal world can request the NPU for AI model execution via a protected channel provided by an inter-processor interface. The NPU accesses the prepared model in the secure memory and performs inference operations. The NPU may store the inference results in a protected portion of the system memory (referred to as “protected memory”). That is, the NPU has multiple privilege levels, which allow the NPU to access both the protected memory and the secure memory. The NPU driver can retrieve the inference results from the protected memory via the protected channel. In an alternative embodiment, an application that runs in the normal world may directly request a microcontroller in the NPU to perform model preparation. In this alternative embodiment, an NPU driver in the normal world can request the microcontroller for the NPU to execute the AI model via a protected channel provided by the microcontroller.

In one embodiment, a system may support multiple virtual machines (VMs). Some of the VMs may run different operating systems. A VM runs as a process or a set of processes on a host processor, and is allocated with physical computing resources managed by a hypervisor. The hypervisor is responsible for isolating the VMs from one another to ensure each VM can operate independently of the others. The aforementioned NPU driver may run on one of the VMs. In one embodiment, the NPU driver may run on a VM running the Android® operating system (OS) (hereinafter referred to as “Android VM”). In one embodiment, the NPU driver may run on a VM running an OS different from the Android OS (hereinafter referred to as “trusted VM”). A trusted VM’s memory and execution context are hardware-protected from the host OS. The VM that operates the NPU driver is granted access privilege to the protected memory for accessing the output (e.g., output tokens) and intermediate output (e.g., the (key, value) cache (“KV cache”)) of the NPU’s inference operations.

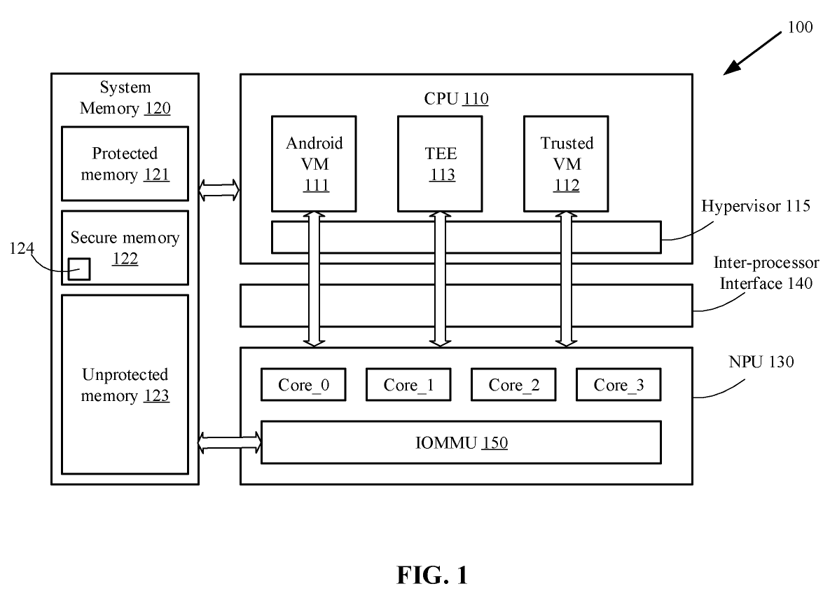

FIG. 1 illustrates a system 100 in which secure AI model inference may be performed according to one embodiment. The system 100 includes general-purpose processors and special-purpose processing circuits. In one embodiment, the system 100 includes a host processor (e.g., a CPU 110) and an NPU 130. Additional processors, such as a graphics processing unit (GPU), a digital signal processor (DSP), etc., may also be included. The system 100 may have any form factor. Non-limiting examples of the system 100 include a smartphone, smart appliance, a desktop computer, a laptop, a server, an Internet-of-Things (IoT) device, an autonomous vehicle, a wearable device, a smart TV, etc.

The system 100 includes a system memory 120, which may further include memory devices such as a dynamic random-access memory (DRAM) module, a static RAM (SRAM) module, a flash memory device, and/or other volatile or non-volatile memory devices. The system memory 120 includes a protected portion, referred to as a protected memory 121, a secure portion, referred to as a secure memory 122, and an unprotected portion, referred to as an unprotected memory 123. The secure memory 122 may store AI model data and metadata, such as model weights 124, model adaptation data (e.g., low-rank adaptation (LoRa) data), and model runtime, etc. The protected memory 121 may store outputs and intermediate outputs of AI model execution to protect a user’s privacy data. For LLM execution, the protected memory 121 may store a KV cache containing a user’s prompt context, a cache mask, rotary embedding, intermediate and final output tokens, etc. A process such as a VM in the normal world needs to be given access privilege to access the data in the protected memory.

In a scenario where user data privacy is not a concern, the KV cache, cache mask, rotary embedding, intermediate and final output tokens, etc., may be stored in the unprotected memory 123. Although the system memory 120 is represented by one block in FIG. 1, it is understood that the system memory 120 may include multiple memory devices across multiple levels of memory hierarchy. It is understood that the system 100 is simplified for illustration; additional hardware and software components (e.g., network interface, display, user interface, etc.) are not shown.

In one embodiment, one or more VMs run on the CPU 110 in the normal world. For example, the VMs in the normal world may include an Android VM 111 and/or a trusted VM 112. The trusted VM 112 provides an isolated and protected environment for AI model processing. A hypervisor 115 runs on the CPU 110 to enforce isolation among the VMs. The CPU 110 provides a TEE 113 for secure-world operations isolated from the normal world. AI models can be decrypted and prepared within the TEE 113 to prevent unauthorized access. In one embodiment, a secure process such as a secure VM may run in the TEE 113, referred to as a TEE VM. The TEE VM operates in the secure world and is isolated from the normal world. Even the hypervisor 115 cannot access the code and data in the TEE VM. Processes or VMs in the TEE 113 have the privilege to access the secure memory 122. The secure memory 122 is inaccessible to CPU processes outside the TEE 113.

In one embodiment, the NPU 130 includes multiple cores (four cores are shown as an example). The cores perform AI computing including but not limited to neural network computing, machine learning, deep learning, and the like. The computations performed by the cores may include executing one or more multi-layered neural networks, one or more AI models, machine learning algorithms, etc. The cores may execute different AI models, the same AI model on different subsets of data (i.e., different regions of an input activation), or different subgraphs of an AI model. Each core can be configured to execute in a secure mode with isolated resources in the NPU 130. For secure AI model execution described herein, the core or cores of the NPU 130 are configured in the secure mode and are referred to as “secure core(s)”. The secure cores have the privilege to access the protected memory 121 and the secure memory 122.

In one embodiment, the VMs on the CPU 110 may communicate with the NPU 130 via an inter-processor interface 140. The inter-processor interface 140 provides a protected channel with hardware (e.g., a register) dedicated to the communication between a VM (e.g., the Android VM 111 or the trusted VM 112) and the NPU 130. For example, the VM and the NPU 130 may send notifications or interrupts to each other using the dedicated hardware as a mailbox. The protected channel is for the NPU 130 and this VM only. Protected channels for different VMs are isolated from one another to ensure secure communication between the NPU 130 and each of the VMs. Communication on the protected channel follows a secure software protocol to enforce data isolation and protection for each protected channel without interference from another channel. For example, when a new data item is placed in the buffer, an interrupt signal is triggered to alert the receiving side. The inter-processor interface 140 enables a normal-world VM (e.g., the Android VM 111 or the trusted VM 112) to directly request the NPU 130 for secure AI model execution, without the overhead of the TEE 113 handling data copying between the VM and the NPU 130. In one embodiment, the inter-processor interface 140 further provides a secure channel for the TEE 113 to communicate with the NPU 130, where the secure channel is restricted to the secure world. The protected channel dedicated to a normal-world VM (e.g., the Android VM 111 or the trusted VM 112) is isolated from the secure channel for the TEE 113.

In one embodiment, the NPU 130 also includes an input/output memory management unit (IOMMU) to enforce memory isolation between different software contexts and enable the NPU 130 to securely access the system memory 120.

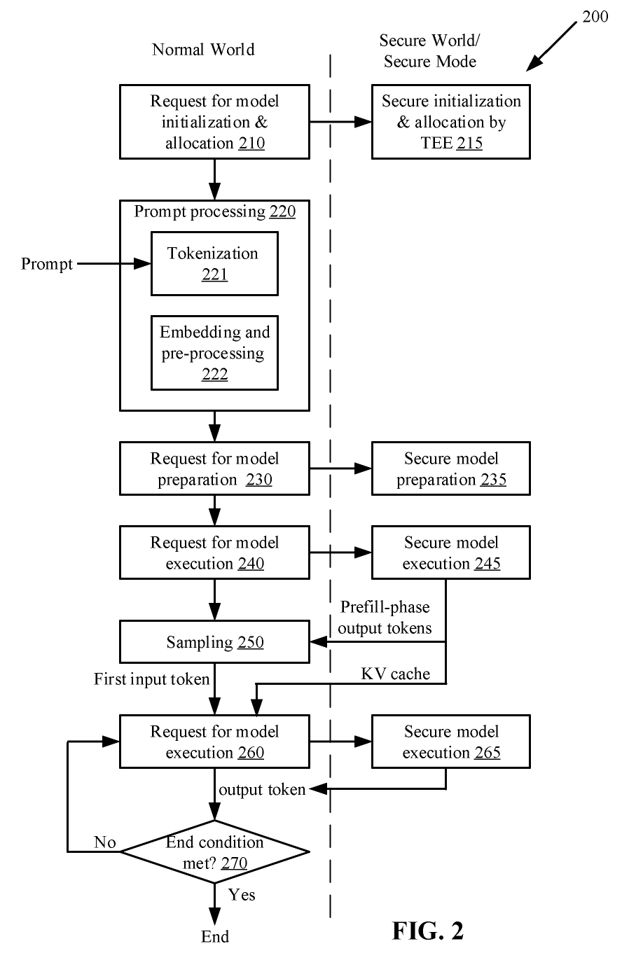

FIG. 2 illustrates a process 200 of LLM inference operations according to one embodiment. The process 200 is performed by a system such as the system 100 of FIG. 1. Referring also to FIG. 1, the process 200 includes normal-world operations by one or more VMs (e.g., the Android VM 111 and/or the trusted VM 112), secure-world operations by the TEE 113, and secure-mode operations by the NPU 130. Initially, a VM (e.g., the Android VM 111 or the trusted VM 112) is created in the normal world on the CPU 110 to handle LLM inference requests from users. The process 200 begins with the VM at step 210 requesting secure operations of initializing and allocating physical memory space for incoming LLM inference. In one embodiment, the task of initializing and allocating the physical memory space is handled by the TEE 113 at step 215.

The VM at step 220 receives a prompt and performs prompt processing, which includes tokenization of the prompt (step 221), token embedding and other pre-processing operations (step 222) for setting up the input to the LLM. In one scenario, the prompt may be partitioned into multiple segments for processing, one segment at a time. At step 230, a model preparation client running on the VM requests the TEE 113 for secure model preparation. The TEE 113 performs secure model preparation at step 235, including decrypting model data, adjusting model weight formats and/or precision, setting up model configurations, etc. The prepared model is stored in the secure memory 122.

At step 240, a prefill phase of model execution begins. The VM (or a second VM invoked by the VM) requests the NPU 130 to execute the LLM using the prepared model and the tensors constructed from the prompt. In the prefill phase, the NPU 130 builds a KV cache to store the prompt context, and outputs a set of prefill phase output tokens (also referred to as the “prefill tokens”). The NPU 130 can generate hundreds or more prefill tokens in parallel. After the entire prompt is processed and the context of the entire prompt is stored in the KV cache, the process 200 proceeds to a sampling operation 250. At step 250, the VM samples the prefill tokens to select one as the first input token for the next phase, which is called the token generation phase. As an example, the first input token may be the prefill token having the highest confidence value, or a prefill token selected by a probabilistic method. At step 260, the VM (or the second VM invoked by the VM) requests the NPU 130 to use the input token to securely execute the LLM and generate an output token. In the token generation phase, the output token is generated auto-regressively in a loop, one output token per iteration of the loop. At step 265, the NPU 130 generates output tokens, using the KV cache to accelerate the attention computations. Step 260 is repeated until a stopping condition is met (e.g., maximum number of iterations or execution time is reached) at step 270.

To protect the data integrity of the LLM, the NPU 130 executes the LLM in the secure mode. The LLM execution may be performed in response to a request from an NPU driver operating on the Android VM 111 or the trusted VM 112. The communication between the NPU driver and the NPU 130 goes through a protected channel, which isolates and protects the communication from other VMs or software in the normal world.

In a conventional system, a client in the normal world communicates with an NPU through the TEE. The client requests the NPU through the TEE to generate each output token in the token generation phase. Each output token generated by the NPU is copied from a secure memory to an unprotected memory for the client to access. Each security boundary-crossing between the normal world (the client) and the secure world (the TEE) needs to be verified and follows strict security rules. As the output tokens are generated one at a time during the token generation phase, the communication through the TEE causes significant latency and performance degradation as a result of the time spent on the TEE boundary-crossing. Therefore, the conventional system is not scalable with the size of the output tokens.

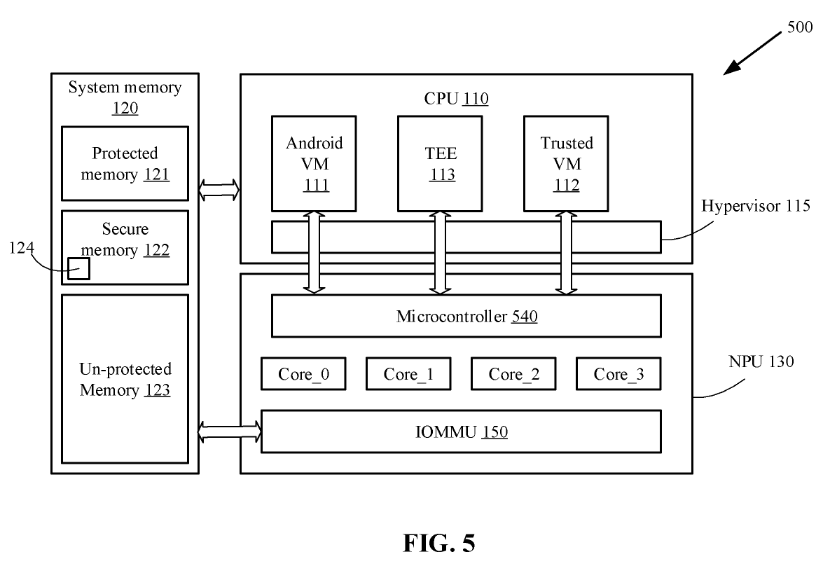

The embodiments described herein provide a scalable and efficient solution for AI model inference operations while maintaining the security of model execution. A normal-world VM may request an NPU for model execution via a protected channel provided by an inter-processor interface (e.g., the inter-processor interface 140 in FIG. 1) or a microcontroller (e.g., the microcontroller 540 in FIG. 5) without going through the TEE. For LLM execution, an NPU driver running on the VM can directly communicate with the NPU via the protected channel without the intervention of the TEE. This direct communication channel enables significant reduction in model execution time, especially in the token generation phase. As a result, the system performance (e.g., the time from receiving the prompt to producing a first output token, and/or the total inference time) can be greatly improved.

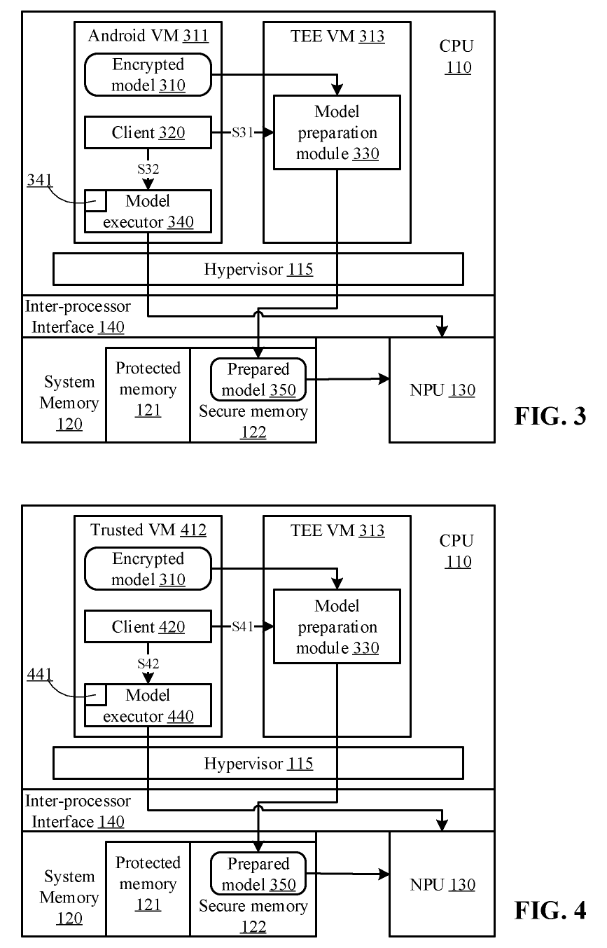

FIG. 3 is a diagram illustrating a control flow of AI model inference operations according to a first embodiment. In this embodiment, an Android VM 311 receives an encrypted model 310. The Android VM 311 may be an example of the Android VM 111 in FIG. 1. The Android VM 311 receives a prompt and performs prompt processing. At step S31, a client 320 in the Android VM 311 requests a model preparation module 330 in a TEE VM 313 to prepare the encrypted model 310 for execution. An example of model preparation is described at steps 230 and 235 in FIG. 2. A prepared model 350 is stored in the secure memory 122 accessible to only the TEE VM 313 and the secure cores in the NPU 130. At step S32, the client 320 invokes a model executor 340 in the Android VM 311 to request the NPU 130 to execute the prepared model 350. An NPU driver 341 in the model executor 340 sends the request to the NPU 130 via a protected channel provided by the inter-processor interface 140. The protected channel is dedicated to the communication between the NPU driver 341 and the NPU 130. The protected channel enables the communication without the intervention of the TEE VM 313.

FIG. 4 is a diagram illustrating a control flow of AI model inference operations according to a second embodiment. The control flow in this embodiment is the same as the control flow in FIG. 3, except that the Android VM 313, the client 320, the model executor 340, and the NPU driver 341 are replaced by a trusted VM 412, a client 420, a model executor 440, and an NPU driver 441, respectively. The trusted VM 412 may be an example of the trusted VM 112 in FIG. 1. The trusted VM 412 receives a prompt and performs prompt processing. At step S41, the client 420 in the trusted VM 412 requests the model preparation module 330 in the TEE VM 313 to prepare the encrypted model 310 for execution. At step S42, the client 420 invokes the model executor 440 to request the NPU 130 to execute the prepared model 350. The NPU driver 441 in the model executor 440 sends the request to the NPU 130 via a protected channel provided by the inter-processor interface 140. The protected channel is dedicated to the communication between the NPU driver 441 and the NPU 130. The protected channel enables the communication without the intervention of the TEE VM 313.

FIG. 5 illustrates a system 500 in which secure AI model inference operations may be performed according to another embodiment. The system 500 includes the same components as the system 100 in FIG. 1, except that the inter-processor interface 140 is replaced by a microcontroller 540 in the NPU 130. The microcontroller 540 provides a protected channel with hardware (e.g., a register) dedicated to the communication between the NPU 130 and the VM (e.g., the Android VM 111 or the trusted VM 112) that requests secure AI model execution. For example, the VM and the NPU 130 may send notifications or interrupts to each other using the dedicated hardware as a mailbox. The protected channel is for the NPU 130 and this VM only. Protected channels for different VMs are isolated from one another to ensure secure communication between the NPU 130 and each of the VMs. Communication on the protected channel follows a secure software protocol to enforce data isolation and protection for each protected channel without interference from another channel. Additionally, the microcontroller 540 performs the secure AI model preparation (step 235 in FIG. 2), which can further reduce the overhead caused by the TEE 113 and improve system performance,

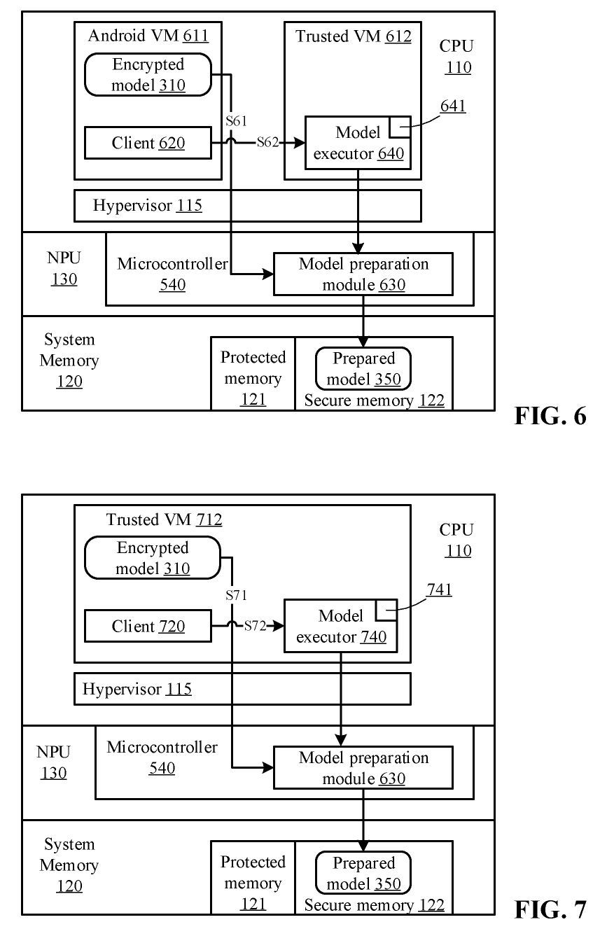

FIG. 6 is a diagram illustrating a control flow of AI model inference operations according to a third embodiment. In this embodiment, an Android VM 611 receives the encrypted model 310. The Android VM 611 may be an example of the Android VM 111 in FIG. 5. The Android VM 611 receives a prompt and performs prompt processing. At step S61, a client 620 in the Android VM 611 requests a model preparation module 630 in the microcontroller 540 to prepare the encrypted model 310 for execution. An example of model preparation is described at steps 230 and 235 of FIG. 2. The prepared model 350 is stored in the secure memory 122 accessible only to the NPU 130 (including the microcontroller 540) in the secure mode. At step S62, the client 620 invokes a model executor 640 in a trusted VM 612 to send a request to the microcontroller 540 for executing the prepared model 350. The trusted VM 612 may be an example of the trusted VM 112 in FIG. 5. An NPU driver 641 in the model executor 640 sends the request to the NPU 130 via a protected channel provided by the microcontroller 540. The microcontroller 540 dedicates the protected channel to the communication between the NPU driver 641 and the NPU 130. The protected channel enables the communication without the intervention of a TEE process.

FIG. 7 is a diagram illustrating a control flow of AI model inference operations according to a fourth embodiment. In this embodiment, a trusted VM 712 includes both a client 720 and a model executor 740. The trusted VM 712 may be an example of the trusted VM 112 in FIG. 5. The trusted VM 712 receives the encrypted model 310. The trusted VM 712 further receives a prompt and performs prompt processing. At step S71, the client 720 requests the model preparation module 630 in the microcontroller 540 to prepare the encrypted model 310 for execution. The prepared model 350 is stored in the secure memory 122 accessible only to the NPU 130 (including the microcontroller 540) in the secure mode. At step S72, the client 720 invokes the model executor 740 to send a request to the microcontroller 540 for executing the prepared model 350. An NPU driver 741 in the model executor 740 sends the request the NPU 130 via a protected channel provided by the microcontroller 540. The microcontroller 540 dedicates the protected channel to the communication between the NPU driver 741 and the NPU 130. The protected channel enables the communication without the intervention of a TEE process.

In the embodiments shown in FIGS. 3, 4, 6, and 7, the intermediate results of model execution, such as the KV cache, may be stored in the protected memory 121. Both the NPU 130 and the client (320, 420, 620, or 720) are granted the privilege to access the protected memory 121. In an alternative embodiment, the intermediate results such as the KV cache may be stored in the unprotected memory 123 when there are no user data privacy concerns. In one embodiment, the AI model may be an LLM.

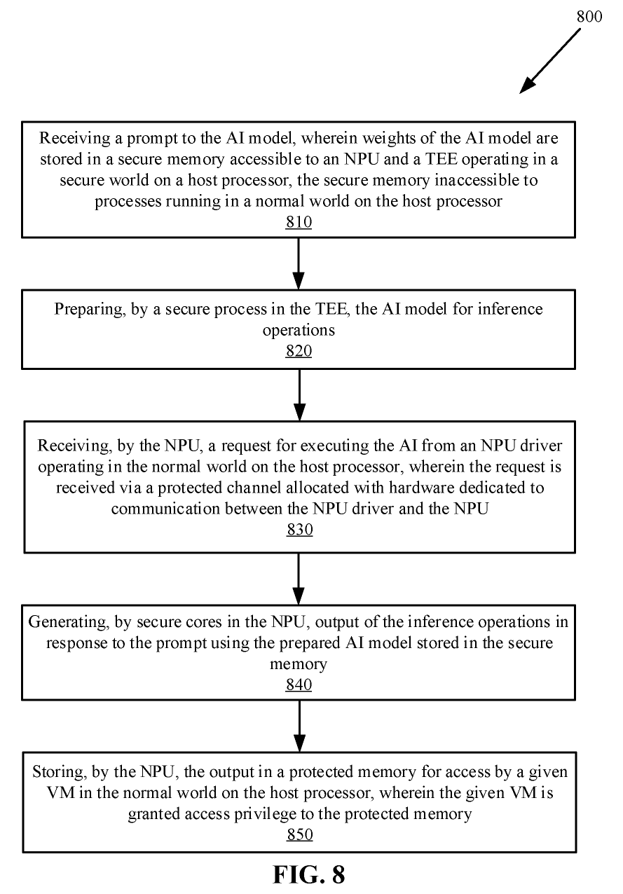

FIG. 8 is a flow diagram illustrating a method 800 of secure execution of an AI model according to one embodiment. In one embodiment, the method 800 may be performed by the system 100 of FIG. 1.

In one embodiment, the method 800 begins at step 810 when the system receives a prompt to an AI model. The weights of the AI model are stored in a secure memory accessible to an NPU and a TEE operating in a secure world on a host processor. The secure memory is inaccessible to processes running in a normal world on the host processor. At step 820, a secure process in the TEE prepares the AI model for inference operations. At step 830, the NPU receives a request for executing the AI from an NPU driver operating in the normal world on the host processor. The request is received by the NPU via a protected channel allocated with hardware dedicated to communication between the NPU driver and the NPU. At step 840, secure cores in the NPU generate output of the inference operations in response to the prompt using the prepared AI model stored in the secure memory. At step 850, the NPU stores the output in a protected memory for access by a given VM in the normal world on the host processor. The given VM is granted access privilege to the protected memory.

In one embodiment, the protected memory is allocated for storing the output and intermediate output of the inference operations, and the intermediate output includes a KV cache. In one embodiment, the given VM is an Android VM on which the NPU driver operates, and the Android VM processes the prompt to generate input to the AI model. In another embodiment, the given VM is a trusted VM on which the NPU driver operates, and the trusted VM processes the prompt to generate input to the AI model. In one embodiment, the protected channel is provided by an inter-processor interface and is isolated from a secure channel via which the TEE communicates with the NPU. In one embodiment, the AI model is an LLM.

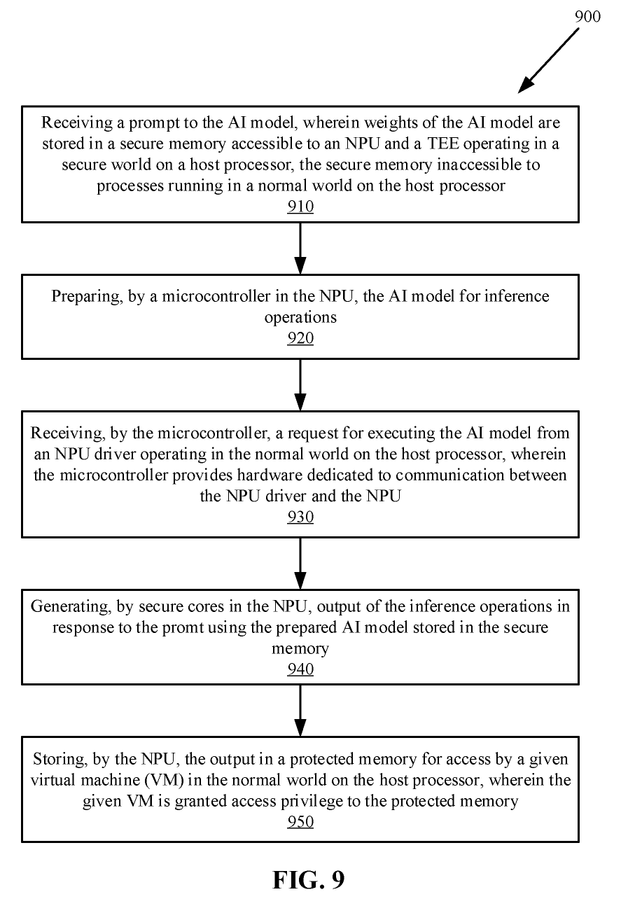

FIG. 9 is a flow diagram illustrating a method 900 of secure execution of an AI model according to another embodiment. In one embodiment, the method 900 may be performed by the system 500 in FIG. 5.

In one embodiment, the method 900 begins at step 910 when the system receives a prompt to the AI model. The weights of the AI model are stored in a secure memory accessible to an NPU and a TEE operating in a secure world on a host processor. The secure memory is inaccessible to processes running in a normal world on the host processor. At step 920, a microcontroller in the NPU prepares the AI model for inference operations. At step 930, the microcontroller receives a request for executing the AI model from an NPU driver operating in the normal world on the host processor. The microcontroller provides hardware dedicated to communication between the NPU driver and the NPU. At step 940, secure cores in the NPU generate output of the inference operations in response to the prompt using the prepared AI model stored in the secure memory. At step 950, the NPU stores the output in a protected memory for access by a given VM in the normal world on the host processor. The given VM is granted access privilege to the protected memory.

In one embodiment, the given VM is a trusted VM on which the NPU driver operates, and an Android VM processes the prompt to generate input to the AI model and invokes the trusted VM to have the NPU driver send the request to the NPU. In another embodiment, the given VM is a trusted VM on which the NPU driver operates, and the given VM processes the prompt to generate input to the AI model. In one embodiment, the AI model is an LLM. In one embodiment, preparing the AI model further comprises decrypting the AI model.

The operations of the flow diagrams of FIGS. 8 and 9 have been described with reference to the exemplary embodiments of FIGS. 1 and 5. However, it should be understood that the operations of the flow diagrams of FIGS. 8 and 9 can be performed by embodiments of the invention other than the embodiments of FIGS. 1 and 5, and the embodiments of FIGS. 1 and 5 can perform operations different than those discussed with reference to the flow diagrams. It is understood that the order of operations shown in the flow diagrams of FIGS. 8 and 9 is a non-limiting example. Alternative embodiments may perform the operations in a different order, combine certain operations, overlap certain operations, etc.

Various functional components or blocks have been described herein. As will be appreciated by persons skilled in the art, the functional blocks will preferably be implemented through circuits (either dedicated circuits or general-purpose circuits, which operate under the control of one or more processors and coded instructions), which will typically comprise transistors that are configured in such a way as to control the operation of the circuitry in accordance with the functions and operations described herein.

While the invention has been described in terms of several embodiments, those skilled in the art will recognize that the invention is not limited to the embodiments described, and can be practiced with modification and alteration within the spirit and scope of the appended claims. The description is thus to be regarded as illustrative instead of limiting.

What is claimed is:

1. A method for secure execution of an artificial intelligence (AI) model, comprising:
receiving a prompt to the AI model, wherein weights of the AI model are stored in a secure memory accessible to a neural processing unit (NPU) and a trusted execution environment (TEE) operating in a secure world on a host processor, the secure memory inaccessible to processes running in a normal world on the host processor;
preparing, by a secure process in the TEE, the AI model for inference operations;
receiving, by the NPU, a request for executing the AI model from an NPU driver operating in the normal world on the host processor, wherein the request is received via a protected channel allocated with hardware dedicated to communication between the NPU driver and the NPU;
generating, by secure cores in the NPU, output of the inference operations in response to the prompt using the prepared AI model stored in the secure memory; and
storing, by the NPU, the output in a protected memory for access by a given virtual machine (VM) in the normal world on the host processor, wherein the given VM is granted access privilege to the protected memory.

2. The method of claim 1, wherein the protected memory is allocated for storing the output and intermediate output of the inference operations, and wherein the intermediate output includes a (key, value) cache (KV cache).

3. The method of claim 1, wherein the given VM is an Android VM on which the NPU driver operates, and wherein the Android VM processes the prompt to generate input to the AI model.

4. The method of claim 1, wherein the given VM is a trusted VM on which the NPU driver operates, and wherein the trusted VM processes the prompt to generate input to the AI model.

5. The method of claim 1, wherein the protected channel is provided by an inter-processor interface and is isolated from a secure channel via which the TEE communicates with the NPU.

6. The method of claim 1, wherein the AI model is a large language model (LLM).

7. The method of claim 1, wherein preparing the AI model further comprises decrypting the AI model.

8. A method for secure execution of an artificial intelligence (AI) model, comprising:
receiving a prompt to the AI model, wherein weights of the AI model are stored in a secure memory accessible to a neural processing unit (NPU) operating in a secure world on a host processor and inaccessible to processes running in a normal world on the host processor;
preparing, by a microcontroller in the NPU, the AI model for inference operations;
receiving, by the microcontroller, a request for executing the AI model from an NPU driver operating in the normal world on the host processor, wherein the microcontroller provides hardware dedicated to communication between the NPU driver and the NPU;
generating, by secure cores in the NPU, output of the inference operations in response to the prompt using the prepared AI model stored in the secure memory;
storing, by the NPU, the output in a protected memory for access by a given virtual machine (VM) in the normal world on the host processor, wherein the given VM is granted access privilege to the protected memory.

9. The method of claim 8, wherein the protected memory is allocated for storing the output and intermediate output of the inference operations, and wherein the intermediate output includes a (key, value) cache (KV cache).

10. The method of claim 8, wherein the given VM is a trusted VM on which the NPU driver operates, and wherein an Android VM processes the prompt to generate input to the AI model and invokes the trusted VM to have the NPU driver send the request to the NPU.

11. The method of claim 8, wherein the given VM is a trusted VM on which the NPU driver operates, and wherein the given VM processes the prompt to generate input to the AI model.

12. The method of claim 8, wherein the AI model is a large language model (LLM).

13. The method of claim 8, wherein preparing the AI model further comprises decrypting the AI model.

14. A system operative to perform secure execution of an artificial intelligence (AI) model, comprising:
a system memory including a secure memory and a protected memory;
a neural processing unit (NPU) including a microcontroller and secure cores operating in a secure mode; and
a host processor that runs a plurality of virtual machines (VMs) in a normal world, wherein the system is operative to:
receive a prompt to the AI model, wherein weights of the AI model are stored in a secure memory accessible to the NPU and inaccessible to VMs running in the normal world;
prepare, by the microcontroller, the AI model for inference operations;
receive, by the microcontroller, a request for executing the AI model from an NPU driver operating in the normal world on the host processor, wherein the microcontroller provides hardware dedicated to communication between the NPU driver and the NPU;
generate, by the secure cores in the NPU, output of the inference operations in response to the prompt using the prepared AI model stored in the secure memory; and
store, by the NPU, the output in a protected memory for access by a given VM in the normal world on the host processor, wherein the given VM is granted access privilege to the protected memory.

15. The system of claim 14, wherein the protected memory is allocated for storing the output and intermediate output of the inference operations, and wherein the intermediate output includes a (key, value) cache (KV cache).

16. The system of claim 14, wherein the given VM is a trusted VM on which the NPU driver operates, and wherein an Android VM processes the prompt to generate input to the AI model and invokes the trusted VM to have the NPU driver send the request to the NPU.

17. The system of claim 14, wherein the given VM is a trusted VM on which the NPU driver operates, and wherein the given VM processes the prompt to generate input to the AI model.

18. The system of claim 14, wherein the AI model is a large language model (LLM).

19. The system of claim 14, wherein the microcontroller prepares the AI model by decrypting the AI model.
